(19) United States
(12) Patent Application Publication
(10) Pub. No.: US 2005/0282446 A1
(43) Pub. Date: Dec. 22, 2005

(54) Sliding contact

(75) Inventors: Bernd Gehlert, Bruchkobel (DE); Wulf Kock, Alzenau (DE); Ingo Prunzel, Bruchkobel (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: W. C. Heraeus GmbH

(21) Appl. No.: 11/153,651

(22) Filed: Jun. 15, 2005

(30) Foreign Application Priority Data
Jun. 16, 2004 (DE) 10 2004 028 838.0

(51) Int. Cl. H01R 9/24

(52) U.S. Cl. 439/887

(57) ABSTRACT

A sliding contact has a base structure made from a wire, on whose one end a sliding contact structure is arranged. The sliding contact structure may be on the end face or on a lateral surface of the wire. The siding contact structure may be in a form of a sphere, a wire segment, or a trough-shaped member, for example. One or both of the base structure and the sliding contact structure may be angled or bent.

### BACKGROUND OF THE INVENTION

The invention relates to a sliding contact having a base structure made from a wire.

Such sliding contacts are known, for example, from German published patent application DE 40 20 700 A1. The sliding contact wires disclosed here are rounded at their edges by a laser beam. From U.S. Pat. Nos. 5,315,758 and 5,416,969 sliding contacts are known made from sheet metal strips, which carry contact structures on their ends. Such sliding contacts are used, for example, together with a metallic counter contact in potentiometers, in position sensors, or in rotary switches.

### BRIEF SUMMARY OF THE INVENTION

The invention is based on the object of improving the known sliding contacts.

According to the invention, the object is achieved in that a sliding contact structure is arranged on one end of the wire. In this manner, it is possible to select an economical, springy material for the base structure of the contact, while the part transferring the energy can comprise another material optimized for energy transfer. By the construction of the sliding contact from two different starting parts, different material properties can be realized in a sliding contact, so that the contact can be adapted to the special requirements of its intended use.

Therefore, it is not necessary to arrange the sliding contact structure on the physical end of the wire-shaped base structure. Instead, it can also be arranged at a (relative) end, which is produced, for example, by bending or kinking, and at which the wire comes closest to the counter contact. Therefore, such sliding contacts can also be realized, in which the wire-shaped base structure is held at its (absolute) ends, and a position in-between these ends is provided for the formation of a contact.

Surprisingly, it has been shown that wires, which are used as sliding contacts, can be provided with a sliding contact structure arranged separately, without negatively affecting the spring effect of the wire necessary for making the contact, wherein at the same time the contact resistance with the counter contact can be held low. In this respect, the sliding contacts according to the invention exhibit the advantage of lower material consumption and lower mass relative to known, composite sliding contacts.

Preferably, the sliding contact structure is arranged on the end face of the wire, but an arrangement of the sliding contact structure on the lateral surface of the wire is also possible. Here, it is useful if the sliding contact structure projects beyond one end of the wire in the longitudinal direction of the wire. It can also be useful if the sliding contact structure surrounds the jacket at least at one portion of its periphery, for example, in the form of a longitudinally-cut tube.

It can be useful if the sliding contact structure is embodied as a sphere or as a wire segment. The base structure and/or the sliding contact structure can be angled within themselves and/or relative to each other. The diameter of the sliding contact structure can be approximately as large as the diameter of the base structure. This diameter can preferably equal approximately 50 μm up to 150 μm. In particular, it is an advantage if the sliding contact structure is formed from a noble metal or a noble metal alloy.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1a is a plan view of a sliding contact of one embodiment of the invention having a spherical sliding contact structure;

FIG. 1b is a plan view of a sliding contact similar to that of FIG. 1, except that the spherical contact is on the lateral surface of the wire;

FIG. 2a is a plan view of a sliding contact of another embodiment of the invention, having a wire-shaped contact structure;

FIG. 2b is a plan view of a sliding contact similar to that of FIG. 2a, except that the wire-shaped contact is on a lateral surface of the base structure;

FIG. 3 is a plan view of a modification of the embodiment of FIG. 1a, wherein the spherical contact is on a bent end of the base structure;

FIG. 4a is a plan view of a modification of the embodiment of FIG. 2a, wherein the wire-shaped contact is on a bent end of the base structure;

FIG. 4b is a plan view of a modification of the embodiment of FIG. 2b, similar to the modification of FIG. 4a;

FIG. 5a is a plan view of a further embodiment of the invention, wherein the sliding contact has an angled wire and sliding contact structure;

FIG. 5b is a plan view of a sliding contact similar to that of FIG. 5a, except that the angled sliding contact structure is on a lateral surface of the base structure; and

FIG. 6 is a perspective view of a still further embodiment of a sliding contact of the invention, having a half pipe-shaped sliding contact structure.

### DETAILED DESCRIPTION OF THE INVENTION

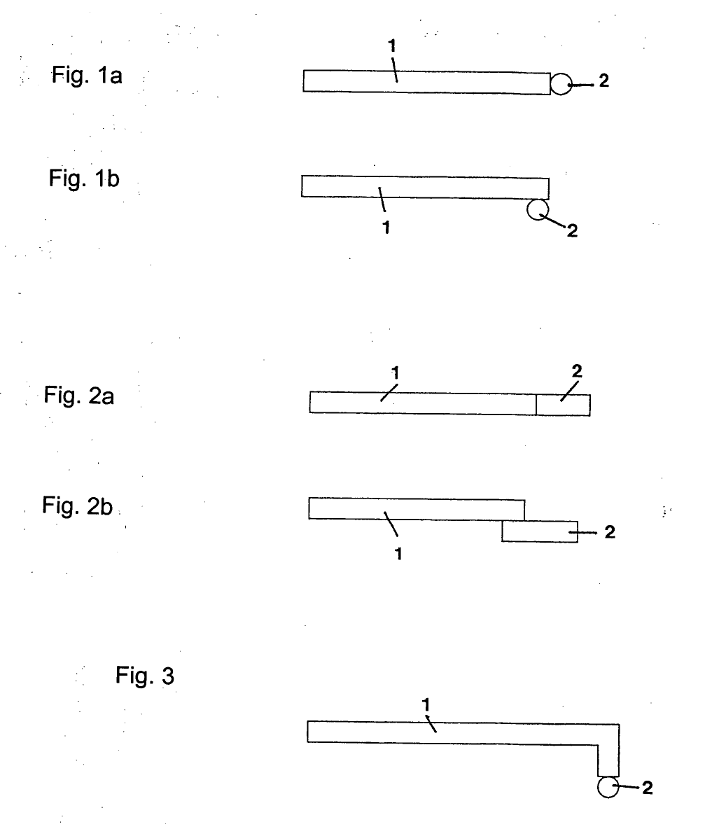

The sliding contacts shown in FIGS. 1a and 1b have a base structure 1 made from a non-noble metal spring wire and a sliding contact structure 2 made from a noble metal ball. The sliding contact structure 2 is fused to the base structure 1 by laser welding or resistance welding.

In the same manner, the sliding contacts shown in FIGS. 2a and 2b can be manufactured, in which instead of a noble metal ball as the sliding contact structure 2, a noble metal wire segment is used. In both cases, the sliding contact structure 2 can be fused either at the end face (FIGS. 1a, 2a) or to the lateral surface of the base structure (FIGS. 1b, 2b).

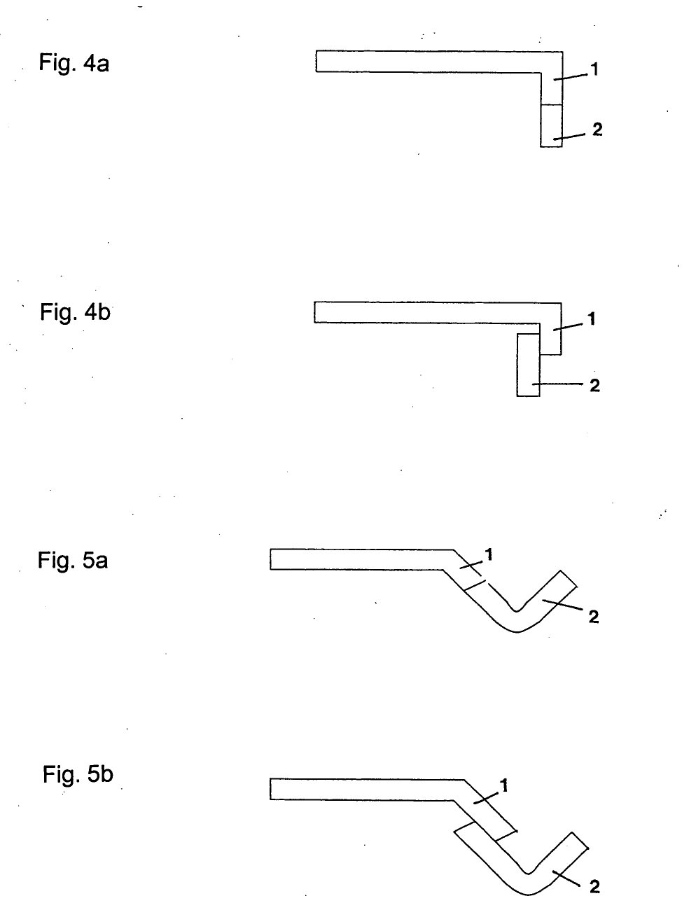

In FIGS. 3, 4a and 4b, similar sliding contacts are shown, in which the base structure 1 is angled (bent). In the embodiment shown in FIGS. 5a and 5b, both the base structure 1 and the sliding contact structure 2 are angled. The angled sliding contacts according to FIGS. 3, 4a and 4 are also known as scraper sliders.

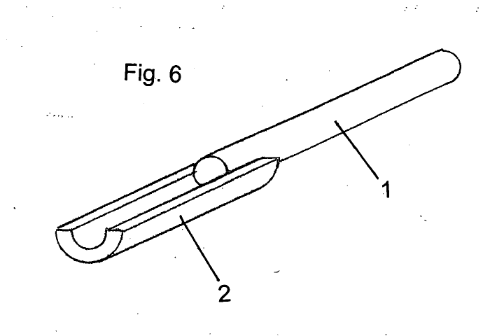

In FIG. 6, another embodiment of the sliding contact according to the invention is shown, in which a semicircular stamped noble metal band in the form of a half pipe is used as the sliding contact structure 2 and is fused around the spring wire forming the base structure 1. The noble metal band can be formed very thin and obtains its stability from the deformed shape and the fixation to the lateral surface of the base structure 1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A sliding contact comprising a base structure made of a wire, wherein a sliding contact structure is arranged on one end of the wire.

2. The sliding contact according to claim 1, wherein the sliding contact structure is arranged on an end face of the wire.

3. The sliding contact according to claim 1, wherein the sliding contact structure is arranged on a lateral surface of the wire.

4. The sliding contact according to claim 3, wherein the sliding contact structure projects beyond the one end of the wire in a longitudinal direction of the wire.

5. The sliding contact according to claim 3, wherein the sliding contact structure surrounds the lateral surface of the wire at least on one portion of its periphery.

6. The sliding contact according to claim 1, wherein the sliding contact structure comprises a ball.

7. The sliding contact according to claim 6, wherein a diameter of the sliding contact structure is approximately as large as a diameter of the base structure.

8. The sliding contact according to claim 6, wherein a diameter at least one of the base structure and the sliding contact structure equals approximately 50 μm to 150 μm.

9. The sliding contact according to claim 1, wherein the sliding contact structure comprises a wire segment.

10. The sliding contact according to claim 9, wherein a diameter of the sliding contact structure is approximately as large as a diameter of the base structure.

11. The sliding contact according to claim 9, wherein a diameter at least one of the base structure and the sliding contact structure equals approximately 50 μm to 150 μm.

12. The sliding contact according to claim 1, wherein at least one of the base structure and the sliding contact structure is angled relative to itself and/or to each other.

13. The sliding contact according to claim 1, wherein the sliding contact structure comprises a noble metal or a noble metal alloy.
